(19) United States
(12) Patent Application Publication
(10) Pub. No.: US 2026/0370181 A1
(43) Pub. Date: Nov. 19, 2026

(54) CLAMP FOR FIXING A PHOTOVOLTAIC MODULE FRAME

(71) Applicant: HANWHA Q CELLS GMBH, Bitterfeld-WAolfen (DE)

(72) Inventors: Heiko Molitor, Bitterfeld-Wolfen (DE); Jan Mamzed, Bitterfeld-Wolfen (DE); Dirk Sachse, Bitterfeld-Wolfen (DE)

(21) Appl. No.: 19/515,856

(22) PCT Filed: Sep. 4, 2024
(86) PCT No.: PCT/EP2024/074762

§ 371 Date: Mar. 3, 2026

(30) Foreign Application Priority Data
Sep. 7, 2023 (DE) 10 2023 124063.3

(51) Int. Cl. H02S 30/10; H02S 20/30

(52) U.S. Cl. CPC H02S 30/10; H02S 20/30

(57) ABSTRACT

A clamp for fixing a photovoltaic module frame, PV module frame, to a substructure. The PV module frame includes a portion that extends parallel to a light incident surface of an installed photovoltaic module, PV. A projection extends within the portion. The clamp includes: a clamping element having at least one notch for receiving the projection; and a clamping device designed to exert a clamping force on the frame via the clamping element when said frame is fixed to the substructure. The at least one notch is designed such that, when the PV module frame is fixed between the clamping element and the substructure, the clamping force is exerted on the portion at at least two pressure points that are situated on opposite sides of the projection.

### PRIORITY CLAIM

The present application is a National Phase entry of PCT Application No. PCT/EP 2024/074762, filed Sep. 4, 2024, which claims priority from German Patent Application 102023124063.3, filed Sep. 7, 2023, the disclosures of which are hereby incorporated by reference herein in their entirety.

### FIELD OF THE INVENTION

The present invention relates to a clamp for fixation of a photovoltaic module frame (PV module frame) and a method for fixing a PV module frame.

### BACKGROUND

Photovoltaic modules are fastened with their frame to a substructure that is intended to hold the photovoltaic modules in a specific position in order to be able to utilize the incident light as efficiently as possible. Ideally, the light incidence direction is perpendicular to the light incident surface of the photovoltaic modules. The fixation of the photovoltaic modules on the substructure is intended to be stable against loads (e.g., wind load and snow load) on the one hand. On the other hand, the photovoltaic modules are intended to be easy to install or replaceable. For example, it repeatedly occurs that individual modules need to be replaced.

Previous fastenings of photovoltaic module frames on substructures fulfill these requirements only partially or require elaborate installations that entail a considerable time expenditure.

Therefore, a need exists for improved fastenings of photovoltaic module frames that do not have the above-mentioned problems.

### SUMMARY OF THE INVENTION

At least a part of the above-mentioned problems is solved by a clamp for fixation of a photovoltaic module frame, PV module frame, to a substructure and a corresponding method for fixing according to claim 11. The dependent claims relate to further advantageous configurations of the clamp or of the substructure.

The present invention relates to a clamp for fixation of a photovoltaic module frame, PV module frame, to a substructure. The PV module frame comprises a portion that extends parallel to a light incident surface of an installed photovoltaic module, PV, and a projection extends within the portion. The clamp comprises: a clamping element with at least one notch for receiving the projection; and a clamping device designed to exert a clamping force via the clamping element on the PV module frame during fixation on the substructure. The at least one notch is configured to, when fixing the PV module frame between the clamping element and the substructure, exert the clamping force at at least two pressure points, which lie on opposite sides of the projection, on the portion.

The two pressure points may also lie on the slopes of the projection or be adjacent thereto. The pressure points lie in a horizontal plane that is parallel to the surface of the photovoltaic module and are spaced apart in a direction that runs perpendicular to the edge of the photovoltaic module. A light incidence direction or the opposite direction may be defined as a vertical direction. According to embodiments, exactly two pressure points on opposite sides are formed for each notch. If the clamping element has two notches for fixation of a PV module frame (and possibly two further notches for fixation of an adjacent PV module frame), then, according to this embodiment, exactly 4 pressure points are formed for the one clamping element for fixation of the PV module frame, namely exactly two for each notch.

Optionally, the clamping element comprises a beveled region configured to facilitate an insertion of the PV module frame between the clamping element and the substructure.

Optionally, the at least one notch comprises a plurality of notches, of which at least two opposite notches are formed mirror-symmetrically to simultaneously fix two adjacent PV module frames on the substructure, wherein the PV module frames may be placed oppositely with respect to the insertion direction.

Optionally, the clamping element has a U-shape and the at least one notch may comprise a plurality of notches, wherein at least one notch is formed in each leg of the U-shape.

Optionally, the clamp further comprises a rotation lock formed as at least one projection on the clamping element to, when fixing the PV module frame on the substructure, engage into the substructure and prevent a rotation of the clamping element relative to the substructure. The rotation lock may, for example, be formed as one or more pin(s) that may have any cross-section (round, triangular, quadrangular, polyhedral).

Optionally, the clamping element comprises an opening (with or without a thread) that couples to the clamping device (e.g., a threaded bolt) to transmit the clamping force to the clamping element.

Optionally, a distance of the notch from a lateral edge of the clamping element is equal to a horizontal extent of the portion up to the projection, to enable a direct contact between the lateral edge of the clamping element and a vertical portion of the PV module frame. This feature provides a bracing effect, so that the stability of the PV module frame as a whole is increased.

Embodiments also relate to a substructure for holding a photovoltaic module frame, PV module frame. The substructure comprises: a holding body and at least one clamp as defined in this disclosure. The clamp is fastened to the holding body and enables a gap between the clamping element and the holding body to allow an insertion of the PV module frame between the holding body and the clamping element.

Optionally, the clamping device is activable from a side opposite to the light incidence plane to generate the clamping force (e.g., a screw connection is tightened from below, wherein “below” is to be understood with respect to the vertical direction).

Further embodiments relate to a system for fixation of a photovoltaic module, which comprises the following: a substructure as defined in this disclosure; and a photovoltaic module frame with a portion that extends parallel to a light incident surface of an installed photovoltaic module. A projection extends within the portion, wherein the projection is formed by a groove on an opposite side that runs longitudinally along an edge of the photovoltaic module frame. This groove or the projection on the other side may be formed by pressing, embossing, or stamping, or by notching.

The photovoltaic module frame may in particular be formed in a single-layered manner, i.e., free of cavities, for example from a flat metal (e.g., by bending, pressing, embossing, etc.). The photovoltaic module frame thereby obtains a certain flexibility but remains firmly fixed to the substructure due to the two-point fixation.

Further embodiments relate to a method for fixing a photovoltaic module frame, PV module frame, to a substructure by means of a clamp as defined in this disclosure. The method comprises:
providing the PV module frame with a portion that extends parallel to a light incident surface of an installed photovoltaic module, PV (i.e., in a horizontal direction), and a projection extends within the portion;
horizontally inserting the PV module frame between the clamp and the substructure; and
applying the clamping force between the clamping element and the substructure by activating the clamping device of the clamp.

“Horizontal insertion” is to be understood as a relative translational movement between the PV module frame and the substructure with the clamps. It is understood that the PV module frame may also remain at rest while the substructure is moved, or conversely, that the substructure remains at rest while the PV module frame is moved, or the PV module frame and the substructure are both moved. Therefore, “insertion” may also be understood as “sliding on” or “sliding in between.” The result will be the same in all cases: the PV module frame is located between the clamps and the substructure.

It is furthermore understood that the PV module frame is fixed together with a photovoltaic laminate held by the PV module frame.

Optionally, the method may therefore further comprise the following:
after the PV module frame (as a first PV module frame) is fixed, horizontally sliding on a further substructure with further clamps into the fastening portion of the fixed PV module frame;
fastening the PV module frame to the further substructure by tightening the further clamps.

Thus, PV module frames with held photovoltaic laminates that are already fixed can be successively fixed laterally to further substructures, and then further PV module frames with held further photovoltaic laminates can be added laterally. The lateral adding may be effected by sliding or moving, wherein the already fixed (fastened) elements remain at rest.

Embodiments overcome the above-mentioned problems in that the clamp fixes the PV module frame simultaneously at at least two holding points, between which a projection (or a groove) is formed in the PV module frame. For this purpose, the clamp has one or more indentations that receive the projection of the PV module frame and thus produce a form-fitting connection. The projection extends along an edge of the photovoltaic module, so that the two holding points are spaced apart from one another in a direction perpendicular to the edge of the photovoltaic module. The projection in the PV module frame may, for example, be formed as a groove parallel to the edge of the photovoltaic module and may be produced by pressing in or bending of the PV module frame (e.g., have a V-shape). Through fixation of the PV module frames on the substructure at the two separate points, which are separated from one another perpendicularly to the module edge, a high stability is achieved, since twisting out during deflection (e.g., under tensile loads as a result of wind) is reliably prevented.

The easy installation is supported according to embodiments in that one or more beveled regions are provided on the clamp that enable easy insertion of the PV module frame. During insertion, the projection snaps into the indentation(s) and thus provides a preliminary hold. Finally, the clamp can be tightened, for which purpose a clamping device (e.g., a screw connection) is used that presses the clamp onto the substructure.

Advantageously, the PV module frame is formed in a C-shape or U-shape, and according to further embodiments, a clamp can simultaneously fix two adjacent PV module frames in spatial proximity. For this purpose, the clamp may, for example, fix the one PV module frame on the left side and the other PV module frame on the right side onto the substructure. After insertion of the two adjacent PV module frames, the clamping device can again be activated to simultaneously hold both PV module frames on the substructure in a form-fitting and force-fitting manner, namely at two or four separate holding points in each case. This offers the advantage that both PV module frames can be mounted very closely together and the gap between them is minimized. By utilizing the C-shape or U-shape, the PV module frames can furthermore in principle adjoin one another without any spacing. Thereby, a maximum light yield can be achieved, so that a maximum of the incident light can be utilized for power generation.

### BRIEF DESCRIPTION OF THE DRAWINGS

The embodiments of the present invention will be better understood from the following detailed description and the accompanying drawings, which, however, should not be understood as limiting the disclosure to the specific embodiments, but merely serve for explanation and understanding.

FIG. 1 shows a clamp for fixing a module frame to a substructure according to an embodiment of the present invention.

FIGS. 2A-2C illustrate details of the clamp according to further embodiments.

FIG. 3 shows a PV module frame that is fastened to the substructure with the clamp.

FIGS. 4A-E show a schematic of the fastening of adjacent modules to a substructure.

### DETAILED DESCRIPTION

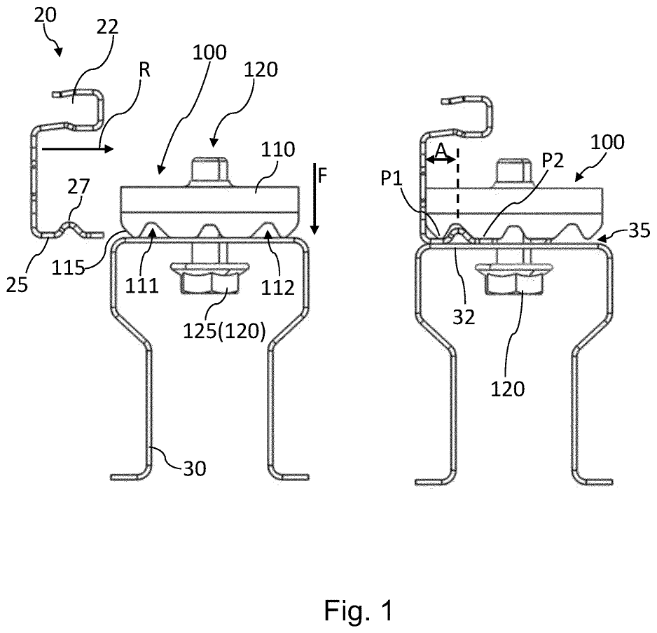

FIG. 1 shows a clamp 100 for fixing a PV module frame 20 to a substructure 30 according to an embodiment of the present invention. The substructure 30 comprises, for example, a (planar) holding body 32 on which the fixation takes place. The PV module frame 20 comprises a gripping portion 22 for holding a photovoltaic module (PV module; not shown in FIG. 1) and a portion 25 that runs parallel to a light incident surface, wherein the light is incident vertically from above. A projection 27 is formed within the portion 25 and may be formed in a V-shape. The clamp 100 comprises a clamping element 110 and a clamping device 120. The clamping element 110 has notches 111, 112 for receiving the projection 27 of the PV module frame 20. The clamping device 120 is designed to exert a clamping force F via the clamping element 110 on the PV module frame 20 during fixation on the holding body 32 on the substructure 30.

The clamping element 110 with the notches 111, 112 is configured to, when fixing the PV module frame 20 between the clamping element 110 and the substructure 30, exert the clamping force F on both opposite sides of the projection 27 on the portion 25. Thus, the clamping force F between the PV module frame 20 and the substructure 30 is not exerted at only one point, but is exerted by the clamp 100 at at least a first pressure point P1 and at a second pressure point P2 that are separated from one another. The projection 27 of the PV module frame 20 is located between the pressure points P1, P2 (see right side of FIG. 1). A high stability is achieved through this two-point mounting; twisting out of the PV module frame 20 is impossible. Even if the clamping force F is low, the PV module frame 20 cannot come loose, since the projection 27 remains hooked in the notch 111 (form-fitting connection). In conventional clamping devices, the PV module frame is clamped at only one location, which can lead to easy loosening.

According to further embodiments, the clamping element 110 comprises one or more beveled regions 115 configured to facilitate insertion of the PV module frames 20 along an insertion direction R between the clamping element 110 and the substructure 30. For example, an angle of the beveled region 115 may be equal in magnitude to the V-shaped projection 27. This enables easy gliding.

The clamping device 120 comprises, in the shown embodiment, by way of example a bolt 125 that engages in a thread of the clamping element 110 and extends through an opening in the holding body 32. Thus, fixation of the PV module frame 20 from a lower side (facing away from the light incidence side) is enabled. Through the screw connection, the clamp 100 is pulled downward by the thread engagement and the clamping force F is thereby applied. The fixation from below offers the advantage that, during an installation in an open field, the fixation can easily be released from below to install or replace PV modules.

According to further embodiments, the fixation may also take place from above, wherein the clamping element in this case only needs to have an opening and a thread or a threaded nut is provided in the substructure.

In the shown embodiment, the PV module frame 20 has a C-shaped or U-shaped cross-section (in a plane that runs perpendicularly through the frame), wherein the portion 25 is formed in the lower section and the gripping portion 22 is formed in the upper part of the C-shape. This offers the advantage that the spacing between the PV modules can be chosen to be arbitrarily small (e.g., by forming the C-shape with a large depth). If the fixation takes place from below, the PV modules can thereby be mounted without any spacing from one another.

An advantage of the beveled region 115 consists, as mentioned, in that easy insertion becomes possible and thus the installation of the PV modules can take place quickly and reliably. For example, the clamp 100 may already be fastened beforehand on the substructure 30, namely such that a distance or gap 35 between the clamping element 110 and the substructure 20 is allowed. The gap 35 may be chosen such that insertion of the PV module frame 20 is just barely possible. In this manner, after insertion of the PV frame 20 and reception of the projection 27 by the notch 111, a temporary securing of the PV module frame 20 can be achieved. The same procedure can be repeated on the other side for a further PV module frame. At the end, the clamping device 120 can then be actuated. The resulting clamping force F then reliably fixes both PV modules.

The clamping device 120 can generate the required clamping force F in a variety of ways, wherein many possibilities are known to a person skilled in the art. For example, one of the following variants or a combination thereof may be used:
a long screw with a nut (from above and/or from below)
a threaded bolt with a nut (from above and/or from below)
a long screw with a thread in the clamp 100 or with a thread in the substructure 30,
an extra thread connected to the clamping element 110 and a counter-bolt,
a threaded rod connected to the clamping element 110 or the substructure 30 and with one or more nuts at the ends.

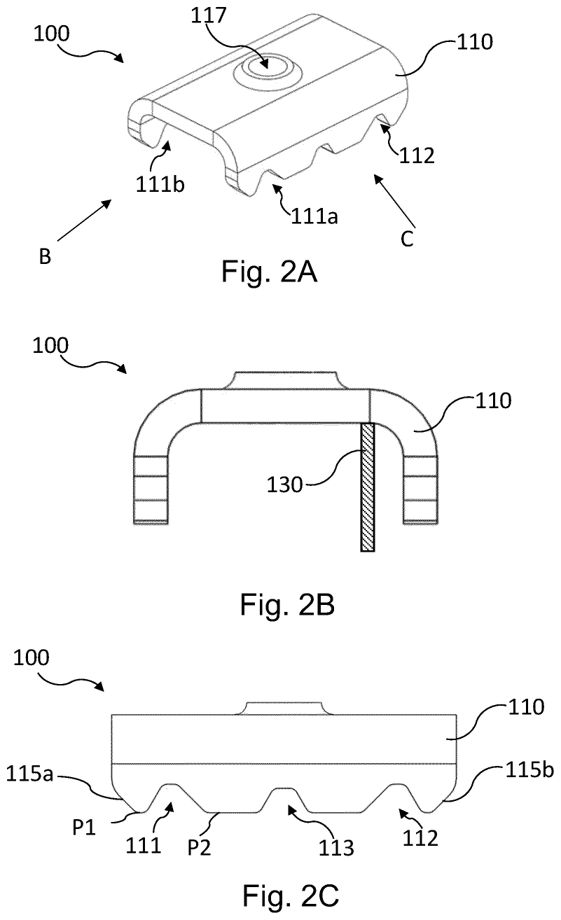

FIG. 2A to 2C show enlarged illustrations of the clamp 100 with further details according to further embodiments, wherein FIG. 2A shows a spatial view, FIG. 2B shows a side view from direction B, and FIG. 2C shows a side view in direction C.

The clamp 100 comprises, in the shown embodiment, additionally a rotation lock 130 (see FIG. 2B). The rotation lock 130 may, for example, be formed by at least one protruding pin or other protruding structures that engage, for example, into the substructure 30. The pin 130 may be arranged offset from the clamping device 120, so that the engagement into the substructure 30 prevents a relative rotation between the clamp 100 and the substructure 30. Corresponding openings or holes may be present in the substructure 30, into which the rotation lock 130 engages. A rotation of the clamp 100 relative to the substructure 30 is then no longer possible, since the clamping device 120, although it may allow a rotation about its own axis, this rotation is blocked by the rotation lock 130 arranged offset with respect to the clamping device.

Furthermore, the clamp 100 according to the shown embodiment may comprise in the clamping element 110 an opening 117 with a thread (see FIG. 2A), in which, for example, the bolt from FIG. 1 can engage to, when fixing the PV module frame 20, pull the clamp 100 toward the substructure 30 and thereby clamp a PV module frame 20 arranged therebetween. A thread does not, however, necessarily have to be present. For example, a bolt may also be inserted from above, the bolt bracing itself with its head against the shown bead of the opening 117 and engaging below with a nut or a thread in the substructure 30. In this case, the clamping can be effected by rotating the bolt from above.

According to the shown embodiment, the clamping element 110 is formed in a U-shape (see FIG. 2B) and the clamping element 110 comprises two notches 111a, 111b, 112 in each of the opposite legs of the U-shaped clamping element 110 (only three are visible), so that the clamping element 110 has a total of four notches, two for each of the adjacently arranged PV module frames 20. This provides the technical effect that the clamping element 110 provides an inherent spring force, since the U-shape can slightly spring in when the clamping force F is applied, which counteracts a loosening of the clamping device 120.

The clamping element 110 in the shown embodiment (see FIG. 2C) comprises a central recess 113 in each of the opposite legs of the U-shaped clamping element 110. These recesses 113 provide the technical effect that the contact pressure at the separate pressure points P1, P2 between the clamping element 110 and the holding body 32 is thereby increased, since the bearing surface of the clamping element 110 on the portion 25 of the PV module frame 20 has been reduced by the recess 113.

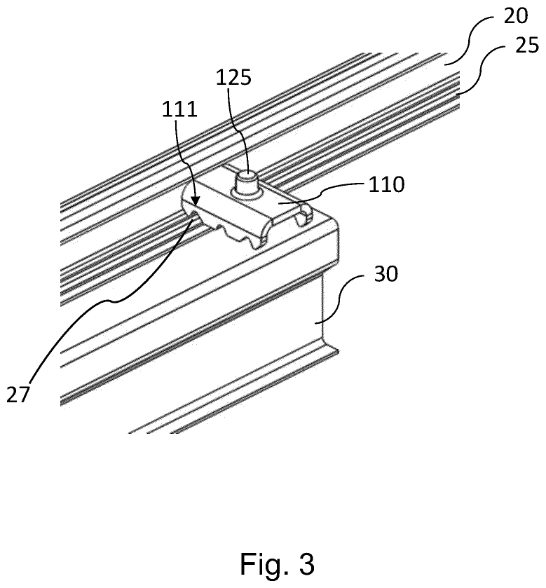

FIG. 3 shows a spatial view of a fixed PV module frame 20 on the substructure 30 by means of the clamp 100. In the shown embodiment, the projection 27 is formed as a groove on the opposite side of the PV module frame 20 and is engaged by the notch 111. The fixation takes place in the present case from below via a bolt 125 that engages, by way of example, in a threaded opening 117 of the clamping element 110.

The clamping element 110 is again formed in a U-shape, wherein each leg of the clamping element 110 fixes the projection 25 of the PV module frame 20 at two mutually spaced-apart pressure points P1, P2 in each case. These four pressure points P1, P2 provide a high stability. The use of a portion 25 of the PV module frame 20 formed in a planar manner also provides a secure hold, since a breaking off of this portion 25 can be virtually ruled out.

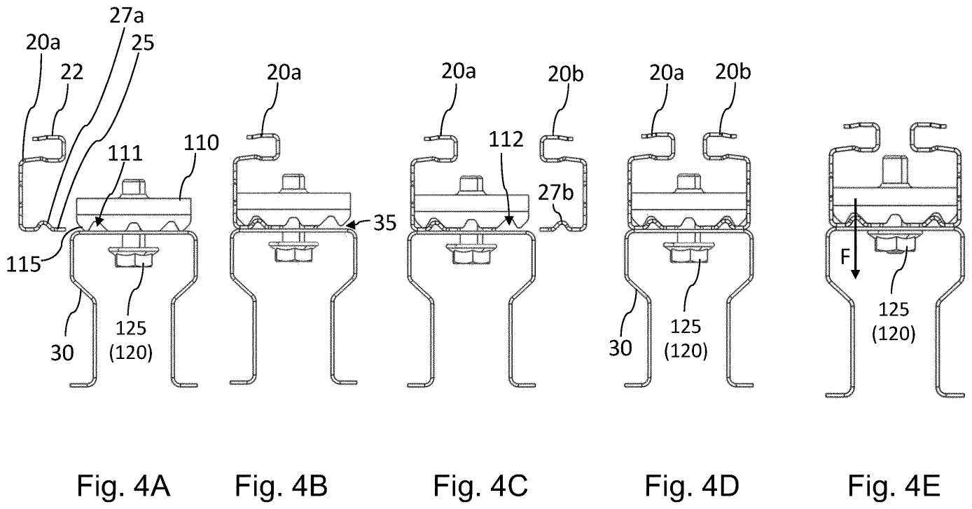

FIGS. 4A to 4E show an exemplary sequence of a fixation of two adjacent PV module frames 20a, 20b on the substructure 30.

FIG. 4A shows the step of providing the first PV module frame 20a and the substructure 30, to which the clamping element 110 with the clamping device120 is already fastened. The clamping device 120 is still deactivated, so that the clamping force F is not yet acting. Therefore, the clamping element 110 can be lifted from the substructure 30 to enable a gap 35. For example, the bolt 125 can be pushed upward by the gap dimension to enable insertion of a first PV module frame 20a.

FIG. 4B shows the step of inserting the first PV module frame 20a between the clamping element 110 and the substructure 30. During insertion, the clamping element 110 is moved vertically upward by the beveled region 115 and the projection 27a of the first PV module frame 20a snaps into the notch 111. After insertion, the clamping element 110 has moved upward by the thickness of the portion 25 of the PV module frame 20a and the first PV module frame 20a is fixed for the time being.

FIG. 4C shows the providing of the second PV module frame 20b on the opposite side. The second PV module frame 20b is mirror-symmetrical to the first PV module frame 20a and likewise comprises a projection 27b that serves for fixation in a second notch 112 of the clamping element 110.

FIG. 4D shows the step of inserting the second PV module frame 20b, which is again inserted horizontally, namely again between the clamping element 110 and the substructure 30. As a result, the two adjacent PV module frames 20a, 20b on both sides of the clamping element 110 are inserted between the clamping element 110 and the substructure 30 far enough that the projections 27a, 27b engage in the notches 111, 112.

FIG. 4E shows the step of applying the clamping force F via the clamping device 120. For this purpose, the bolt 125 can, for example, be tightened from below accordingly, so that the clamping force F acts between the clamping element 110 and the substructure 30 and clamps the PV module frames 20a, 20b located therebetween.

Thus, embodiments also relate to a method for fixing a PV module frame 20 of a photovoltaic module to a substructure 30, wherein at least a part of the steps from FIGS. 4A-4E are carried out in the method.

Advantageously, the PV module frames 20a, 20b are formed in a U-shape or C-shape, wherein the gripping portion 22 is formed on one leg (top in FIG. 4) to hold the PV module. The opposite leg (bottom in FIG. 4) serves as the portion 25 with the projection 27. This provides the technical effect that, through the choice of the depth of the U-shape or C-shape, the spacing of the adjacent PV modules can be adjusted. For example, the spacing can be purposefully chosen to be sufficiently large so that the clamping device 120 (e.g., the bolt 125 or a nut) is accessible from above. However, the spacing can also be chosen to be arbitrarily small (or disappear entirely) if fixation from below is unproblematic.

Embodiments offer the following advantageous aspects:
assembly of the PV module frame from the rear side is possible;
two notches are formed in the clamping element 110 that clamp the lower module legs 25 of the PV modules, wherein the existing groove or the projection is fixed on the right and left side of the groove and thus makes sliding out impossible;
the beveled region 115 on both sides of the clamping element 110 enables sliding of the PV module frame 20 with the projection 27 under the already pre-assembled clamping element 110;
a rotation lock 130 may be present through a projection or a nose in conjunction with a cutout in the substructure 30 to prevent rotation of the clamps 100 during assembly;
the threads may be integrated in the clamping element 110, so that the clamps 110 may already be pre-assembled in a rotationally secure manner.

The features of the invention disclosed in the description, the claims, and the figures may be essential for the realization of the invention both individually and in any combination.

### LIST OF REFERENCE SIGNS

20 photovoltaic module frame (PV module frame)
22 gripping portion for a PV module
25 portion of the PV module frame
27 projection
30 substructure
32 holding body
35 gap
100 clamp
110 clamping element
111, 112 notch(es)
113 recess(es)
115 beveled region (insertion aid)
117 opening (with or without thread)
120 clamping device
125 bolt
130 rotation lock
F clamping force
P1, P2 pressure points on the PV module frame
A distance of the notch from the edge of the clamping element

1. A clamp for fixation of a photovoltaic (PV) module frame to a substructure, wherein the PV module frame has a portion extending parallel to a light incident surface of an installed PV module, and a projection extends within the portion, the clamp comprising:
a clamping element with at least one notch for receiving the projection; and
a clamping device designed to exert a clamping force on the PV module frame via the clamping element when said frame is fixed to the substructure;
wherein the at least one notch is designed such that, when the PV module frame is fixed between the clamping element and the substructure, the clamping force is exerted on the portion at at least two pressure points that are situated on opposite sides of the projection.

2. The clamp according to claim 1, wherein the clamping element further has a beveled region configured to facilitate insertion of the PV module frame between the clamping element and the substructure.

3. The clamp according to claim 1, wherein the at least one notch comprises a plurality of notches, of which at least two opposite notches are formed mirror-symmetrically to simultaneously fix two adjacent PV module frames on the substructure.

4. The clamp according to claim 1, wherein the clamping element has a U-shape and the at least one notch comprises a plurality of notches, wherein at least one notch is formed in each leg of the U-shape.

5. The clamp according to claim 1, further comprising a rotation lock formed as at least one projection on the clamping element to, when fixing the PV module frame on the substructure, engage into the substructure and prevent rotation of the clamping element relative to the substructure.

6. The clamp according to claim 1, wherein the clamping element has an opening, in particular a threaded opening, that couples to the clamping device to transmit the clamping force to the clamping element.

7. The clamp according to claim 1, wherein a distance of the notch from a lateral edge of the clamping element is equal to a horizontal extent of the portion up to the projection, to enable a direct contact between the lateral edge of the clamping element and a vertical portion of the PV module frame.

8. A substructure for holding a photovoltaic (PV) module frame, the substructure comprising:
a holding body; and
at least one clamp according to claim 1, the at least one clamp being fastened to the holding body and enabling a gap between the clamping element and the holding body to allow insertion of the PV module frame between the holding body and the clamping element.

9. The substructure according to claim 8, wherein the clamping device is activated from a side opposite to the light incidence plane to generate the clamping force.

10. A system for fixation of a photovoltaic module, comprising:
a substructure according to claim 8; and
a photovoltaic module frame with a portion extending parallel to a light incident surface of an installed photovoltaic module, and a projection running within the portion, the projection being formed by a groove on an opposite side running longitudinally along an edge of the photovoltaic module frame.

11. A method for fixing a photovoltaic (PV) module frame to a substructure with a clamp according to claim 1, the method comprising:
providing the PV module frame with a portion extending parallel to a light incident surface of an installed PV module and a projection running within the portion;
horizontally inserting the PV module frame between the clamp and the substructure; and
applying the clamping force between the clamping element and the substructure by activating the clamping device of the clamp.

12. The method according to claim 11, further comprising:
after the PV module frame is fixed, horizontally sliding on a further substructure with a further clamp onto the portion with the projection of the fixed PV module frame; and
fastening the PV module frame to the further substructure by tightening the further clamp.
